(19) United States
(12) Patent Application Publication
(10) Pub. No.: US 2016/0219059 A1
(43) Pub. Date: Jul. 28, 2016

(54) METHOD OF PROVIDING TELEMATICS SERVICE AND REGISTERING VEHICLE AND APPARATUS THEREFOR

(71) Applicant: HYUNDAI MOTOR COMPANY, Seoul (KR)

(72) Inventor: Sung Woo PARK, Seoul (KR)

(21) Appl. No.: 14/925,930

(22) Filed: Oct. 28, 2015

(30) Foreign Application Priority Data
Jan. 27, 2015 (KR) 10-2015-0013030

(51) Int. Cl. H04L 29/06; G06F 17/30

(52) U.S. Cl. CPC H04L 63/102; G06F 17/30702; H04L 63/08

(57) ABSTRACT

A method of providing a telematics service and registering a vehicle may acquire member information, create an account using the member information, log in to a telematics system using the created account, provide a telematics service to a vehicle connected to the telematics system, and register the vehicle in a central server. In addition, a method of providing a telematics service and registering a vehicle may acquire login information, log in to a telematics system using the login information, provide a telematics service to a vehicle connected to the telematics system, and register the vehicle in a central server. Accordingly, creating an account, registering a vehicle and adding the vehicle may be realized without using a vehicle identification number (VIN), which allows respective procedures to be rapidly and easily performed.

### CROSS-REFERENCE TO RELATED APPLICATION

This application claims the benefit of Korean Patent Application No. 10-2015-0013030, filed on Jan. 27, 2015 in the Korean Intellectual Property Office, the discourse of which is hereby incorporated by reference as if fully set forth herein.

### TECHNICAL FIELD

The present disclosure relates to a method of providing a telematics service and registering a vehicle and an apparatus therefor, and more particularly, to a method of providing a telematics service and registering a vehicle for simplifying steps of providing the telematics service and registering the vehicle and an apparatus therefor.

### BACKGROUND

Telematics is a compound word formed from telecommunication and informatics, and is also referred to as “automotive telematics” in that an auto PC is used to exchange an e-mail and search for various types of information over the Internet in a vehicle. A driver may use telematics to remotely diagnose a vehicle through a wireless network, utilize various types of information such as traffic information, life information, emergency rescue information, etc. through an auto PC including a wireless modem, deliver a telephone message to an office and friends, exchange a voice e-mail, and download an audio book.

To use telematics, a vehicle needs to be registered and an account needs to be created for each system, and a user with an existing account may need to add a new vehicle. However, procedures of creating an account, registering a vehicle, and adding a vehicle are complicated, and thus the user has difficulty in using telematics.

### SUMMARY

The present invention has been conceived to solve the above-mentioned problem, and an object of the present invention is to provide a method of providing a telematics service and registering a vehicle for simplifying steps of generating an account, registering a vehicle and adding a vehicle for using telematics, and an apparatus therefor.

To achieve these objects and other advantages and in accordance with the purpose of the invention, as embodied and broadly described herein, a method of providing a telematics service and registering a vehicle includes acquiring member information, creating an account using the member information, logging in to a telematics system using the created account, providing the telematics service to a vehicle connected to the telematics system, and registering the vehicle in a central server.

In another aspect of the present invention, a method of providing a telematics service and registering a vehicle includes acquiring login information, logging in to a telematics system using the login information, providing the telematics service to a vehicle connected to the telematics system, and registering the vehicle in a central server.

The method may further include determining whether the telematics service is not provided to the vehicle, wherein the determining includes searching a member database for a vehicle identification number (VIN) of the vehicle.

The method may further include displaying a provision scheme guide.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a diagram illustrating a configuration of a system for providing a telematics service and registering vehicles as an embodiment to which the present invention is applied;

FIG. 2 is a block diagram illustrating respective configurations of a head unit, a mobile terminal and a central server of the system for providing the telematics service and registering vehicles as an embodiment to which the present invention is applied;

FIG. 3 is a block diagram illustrating an example of an operation of creating a user account and registering a vehicle in a central server as an embodiment to which the present invention is applied; and

FIG. 4 illustrates an example of an operation of adding a vehicle of a joining user to use the telematics service as an embodiment to which the present invention is applied.

### DETAILED DESCRIPTION

Terms used in this specification and claims must not be restrictively interpreted as dictionary definitions, and must be interpreted as meanings and concepts corresponding to the technical spirit of the invention based on a principle in which the inventor may appropriately define concepts of terms to describe the invention in the best way.

Therefore, embodiments described in this specification and configurations illustrated in the drawings are merely preferred examples of the present invention and do not fully represent the technical spirit of the present invention. Thus, it should be understood that various equivalents and modified examples may replace the embodiments at the time of the application.

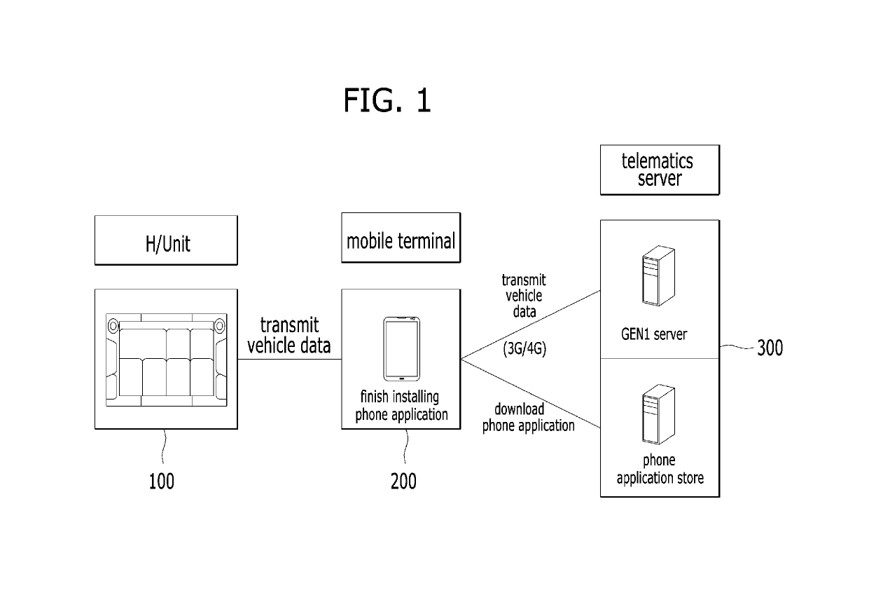

FIG. 1 illustrates a configuration of a system for providing a telematics service and registering vehicles as an embodiment to which the present invention is applied.

A head unit 100 may indicate a unit included in a vehicle. The head unit 100 may exchange data with an external device or a server.

A mobile terminal 200 may indicate a terminal that can be carried by a user. The mobile terminal 200 may include a wireless communication unit, an output unit, a memory, a controller, etc. The mobile terminal 200 may transmit vehicle data to a central server 300 through long-distance communication (3G or 4G communication). In addition, the mobile terminal 200 may receive vehicle data from the head unit 100 through short-range communication (Bluetooth, Wi-Fi, or universal serial bus (USB)).

The central server 300 may indicate a device that exchanges vehicle-related information with the external device. The central server 300 may transmit vehicle data to the mobile terminal 200. The mobile terminal 200 may download a smartphone application from the central server 300.

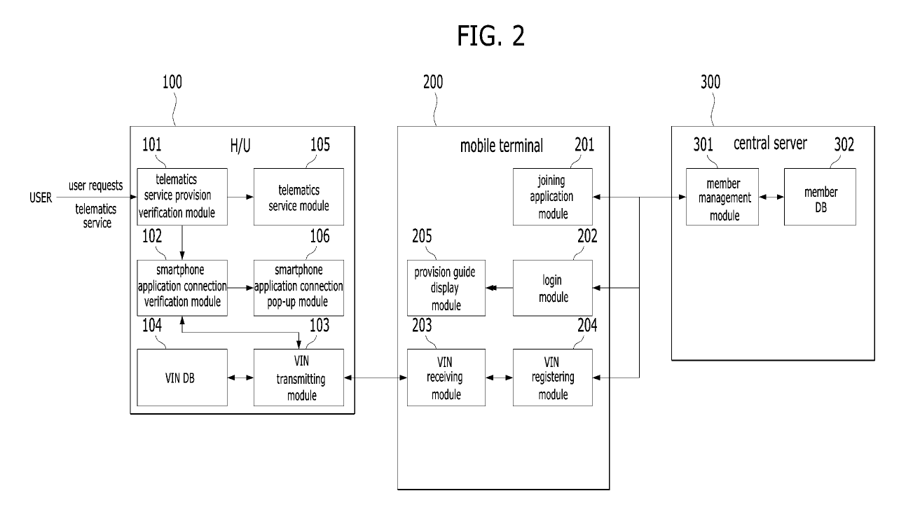

FIG. 2 is a block diagram illustrating respective configurations of the head unit 100, the mobile terminal 200 and the central server 300 of the system for providing the telematics service and registering vehicles as an embodiment to which the present invention is applied.

The head unit 100 may include a telematics service provision verification module 101, a smartphone application connection verification module 102, a vehicle identification number (VIN) transmitting module 103, a VIN database 104, a telematics service module 105 and a smartphone application connection pop-up module 106.

The telematics service provision verification module 101 is a module for verifying whether the telematics service is provided to a head unit of a user when the user requests a telematics service. For example, when the telematics service is provided to the head unit 100, the telematics service module 105 may be requested to provide a service. On the other hand, when the telematics service is not provided to the head unit 100, the smartphone application connection verification module 102 may be requested to transmit a VIN, and a message saying that the telematics service needs to be provided may be displayed on a display unit of the head unit 100.

The smartphone application connection verification module 102 may verify whether an application of the mobile terminal 200 is connected when requested to transmit the VIN. For example, when the head unit 100 is connected to the mobile terminal 200, the smartphone application connection verification module 102 may request the VIN transmitting module 103 to transmit the VIN. On the other hand, when the head unit 100 is not connected to the mobile terminal 200, the smartphone application connection verification module 102 may request the smartphone application connection pop-up module 106 to display a message.

The VIN transmitting module 103 may request the VIN database 104 to transmit the VIN and receive the VIN. The VIN transmitting module 103 may automatically transmit the received VIN to the mobile terminal 200.

The VIN database 104 is a module that stores the VIN of the vehicle. Upon request, the VIN database 104 may transmit the VIN to the VIN transmitting module 103.

The telematics service module 105 may be a module that executes the received request for the telematics service.

The smartphone application connection pop-up module 106 is a display module that displays a message saying that smartphone application connection is needed.

The mobile terminal 200 may include a joining application module 201, a login module 202, a VIN receiving module 203, a VIN registering module 204, and a provision guide display module 205.

The joining application module 201 may transmit a joining request message, member information to be created by the user (ID and password), etc. to a member management module 301 of the central server 300. In addition, the joining application module 201 may receive information about whether the user successfully becomes a member from the member management module 301.

The login module 202 may be a module that transmits the member information provided by the user to the member management module 301. In addition, the login module 202 may receive information about whether logging in is successful and whether the telematics service is provided from the member management module 301. Further, the login module 202 may request the provision guide display module 205 to display a provision guide procedure.

The VIN receiving module 203 may be a module that receives the VIN from the VIN transmitting module 103, and delivers the received VIN to the VIN registering module 204.

The VIN registering module 204 is a module that transmits the delivered VIN and login information to the member management module 301 of the central server 300. In addition, the VIN registering module 204 may receive information about whether the VIN is successfully registered from the member management module 301, and display the information about whether the VIN is successfully registered.

The provision guide display module 205 may display the provision guide procedure upon request from the login module 202.

The central server 300 may include the member management module 301 and a member database 302.

The member management module 301 may transmit a joining page screen in response to the joining request message received from the joining application module 201, receive the member information from the joining application module 201, and determine whether joining is valid by searching the member database 302 for the received member information. In addition, the member management module 301 may transmit information about whether joining is valid to the joining application module 201.

In addition, the member management module 301 may receive login information to be used for logging in from the login module 202, and determine whether it is possible to log in by searching the member database 302 for the login information. In addition, the member management module 301 may transmit information about whether it is possible to log in to the login module 202.

Moreover, the member management module 301 may receive the VIN from the VIN registering module 204, and deliver the VIN to the member database 302 to request that the VIN be stored.

The member database 302 may store the member information, the login information, and the VIN.

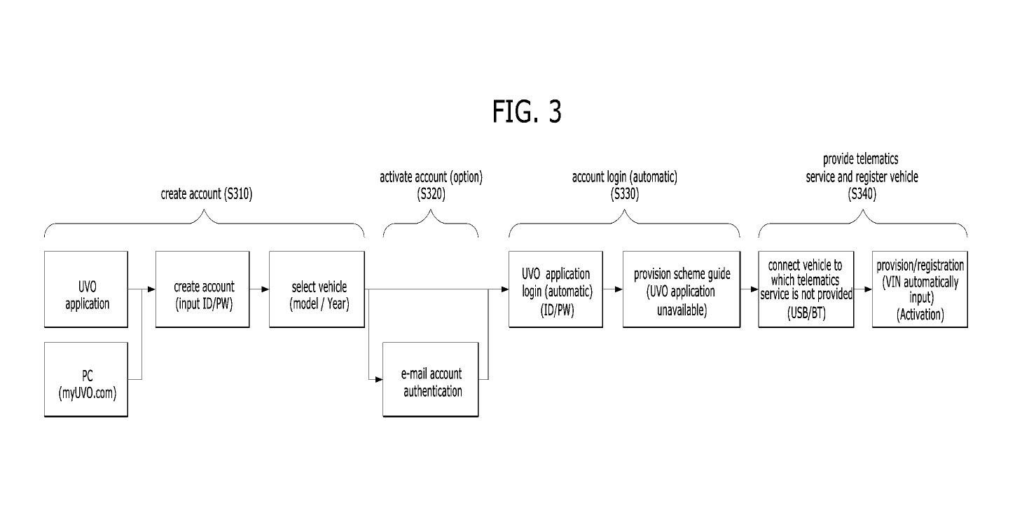

FIG. 3 illustrates an example of an operation of creating a user account and registering a vehicle in the central server 300 as an embodiment to which the present invention is applied.

In S310, the member information may be acquired to create the user account. The user may acquire the member information of the user and vehicle information through a telematics application and a website. Here, the member information may include identification information (ID) and a password, and the vehicle information may include vehicle identification information, a model year, etc.

In S320, the created account may be activated. The created account may be automatically activated after being created. Alternatively, the created account may be activated through an authentication procedure using an e-mail.

In S330, it is possible to log in to a telematics system using the activated account. Logging in may be automatically performed using the activated account. When logging in using the account is completed, a provision scheme guide and a message saying that the telematics service is unavailable before being provided may be displayed.

In S340, the telematics service may be provided to a vehicle, to which the telematics service is not provided, and the vehicle may be registered. A vehicle, to which the telematics service is not provided, of the head unit 100 connected to the mobile terminal 200 may use telematics by providing the telematics service to the vehicle. In addition, a VIN of the vehicle may be transmitted to the central server 300 and registered. The provision scheme guide may be displayed to the user while the telematics service is provided. The provision scheme guide may include a procedure for providing the telematics service and a current service condition.

In S340, it is possible to determine whether the telematics service is not provided to the vehicle. It is possible to determine whether the telematics service is not provided to the vehicle by transmitting the VIN of the vehicle to the central server 300 and searching the member database 302 of the central server 300. When the VIN of the vehicle is not included in the member database 302, the telematics service may be determined not to be provided to the vehicle.

When the account is created and the vehicle is registered using the above-described scheme, it is possible to create the account without the user inputting the VIN, and automatically register the VIN of the vehicle when the telematics service is provided.

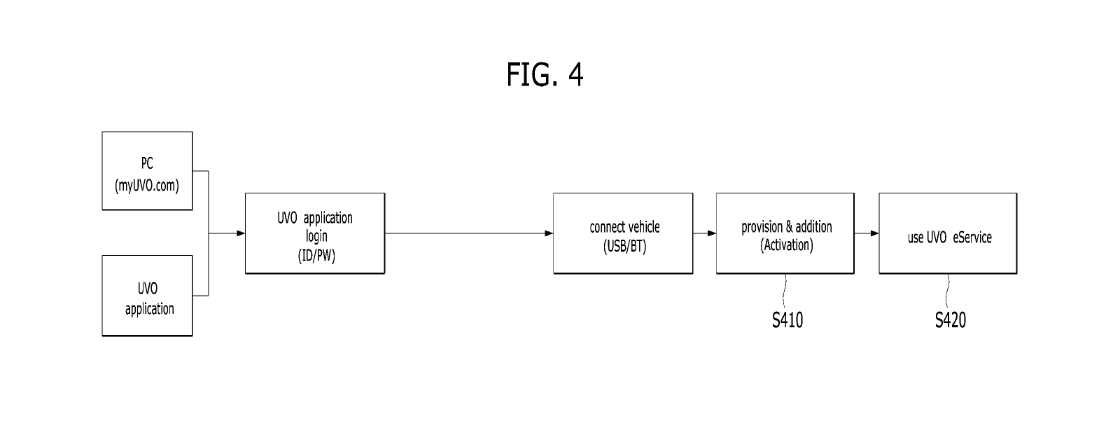

FIG. 4 illustrates an example of an operation of adding a vehicle of a joining user to use the telematics service as an embodiment to which the present invention is applied.

When information about logging in to the telematics system is obtained, and a vehicle is connected, it is possible to determine whether the connected vehicle is connected for the first time (not illustrated). It is possible to determine whether the connected vehicle is connected for the first time by searching the member database 302.

When the connected vehicle is not a previously added vehicle, the telematics service may be provided to the vehicle, and a VIN of the vehicle may be added to the central server 300 in S410.

When the telematics service is provided to the vehicle, to which the telematics service is not provided, and the VIN is registered in the central server 300, the telematics system may be used in the registered vehicle in S420.

The present invention may create an account, register a vehicle and add the vehicle without using a VIN, and thus allows respective procedures to be rapidly and easily performed.

The above-described invention may be implemented as computer-readable code in a medium storing a program. A computer-readable medium includes all types of recording devices storing data that may be read by a computer system. Examples of the computer-readable medium include a read only memory (ROM), a random access memory (RAM), a CD-ROM, a magnetic tape, a floppy disk, an optical data storage, etc. and also include a carrier wave (e.g., data transmission over the Internet).

Therefore, the above-mentioned detailed description must be considered only for illustrative purposes instead of restrictive purposes in all aspects. The scope of the present invention must be decided by a rational analysis of the claims, and all modifications within an equivalent range of the present invention are within the scope of the present invention.

What is claimed is:

1. A method of providing a telematics service and registering a vehicle comprising:
acquiring member information;
creating an account using the member information;
logging in to a telematics system using the created account;
providing the telematics service to a vehicle connected to the telematics system; and
registering the vehicle in a central server.

2. The method according to claim 1, further comprising determining whether the telematics service is not provided to the vehicle,
wherein the determining comprises searching a member database for a vehicle identification number (VIN) of the vehicle.

3. The method according to claim 1, further comprising displaying a provision scheme guide.

4. A method of providing a telematics service and registering a vehicle comprising:
acquiring login information;
logging in to a telematics system using the login information;
providing the telematics service to a vehicle connected to the telematics system; and
registering the vehicle in a central server.

5. The method according to claim 4, further comprising determining whether the telematics service is not provided to the vehicle,
wherein the determining comprises searching a member database for a vehicle identification number (VIN) of the vehicle.

6. The method according to claim 4, further comprising displaying a provision scheme guide.

7. A mobile terminal comprising:
an joining application module for acquiring member information and transmitting the member information to a central server;
a login module for logging in to a telematics system using the member information; and
a vehicle registering module for receiving information about whether the telematics service is provided to a vehicle and whether the vehicle is registered.

8. The mobile terminal according to claim 7, further comprising:
an provision guide display module for displaying a provision guide; and
a VIN receiving module for receiving a VIN of the vehicle.

9. A central server comprising:
a member management module for receiving login information and a VIN from a mobile terminal; and
a member database including previously stored login information and a previously stored VIN,
wherein the member management module determines whether the telematics service is provided to a vehicle corresponding to the received login information and the received VIN by comparing the received login information and the received VIN with the previously stored login information and the previously stored VIN, and obtains a determination result.

10. The central server according to claim 9, wherein the member management module transmits the determination result to the mobile terminal.
